(19) United States
(12) Patent Application Publication
(10) Pub. No.: US 2025/0103928 A1
(43) Pub. Date: Mar. 27, 2025

(54) CONTEXTUAL THOMPSON SAMPLING WITH CORRUPTED AND MISSING CONTEXT

(71) Applicant: INTERNATIONAL BUSINESS MACHINES CORPORATION, ARMONK, NY (US)

(72) Inventor: Djallel BOUNEFFOUF, Poughkeepsie, NY (US)

(21) Appl. No.: 18/373,033

(22) Filed: Sep. 26, 2023

(51) Int. Cl. G06N 7/01

(52) U.S. Cl. CPC G06N 7/01

(57) ABSTRACT

A method, computer program product, and computer system for triggering actions within a multi-armed bandit process with corrupted context. In a current time step: a context vector c(t) is received; a weight a is sampled, from first normal probability distribution, to maximize a function f_{α} of c(t) and ũₐ; functions f₁ₖ are f₂ₖ respectively having and not having a functional dependence on c(t) are determined for each arm k; an arm k(t) is selected to maximize [α(t)f₁ₖ+(1−α(t))f₂ₖ]; an electromagnetic signal is sent to a hardware machine directing the hardware machine to perform an action of the selected arm k(t); a dynamic reward rₖ₍ₜ₎ resulting from the hardware machine having performed the action is received; and updates are performed for the next time step, including updating the first normal probability distribution for α=α(t) as a function of c(t) and rₖ₍ₜ₎ for the selected arm k(t).

### BACKGROUND

The present invention relates generally to a contextual multi-armed bandit method, and more specifically, to a process multi-armed bandit method that combines the standard contextual bandit approach with a classical multi-armed bandit mechanism for dealing with a corrupted-context setting.

### SUMMARY

Embodiments of the present invention provide a method, a computer program product, and a computer system for triggering actions within a multi-armed bandit process with a corrupted context.

One or more processors of a computer system sequentially perform time steps t(t=0, 1, . . . , T), wherein T≥2.

Performing time step 0 comprises: initializing variables and parameters comprising a dimension d≥1 of each context vector to be observed; n weights denoted as α₁, . . . , αₙ such that 0≤αᵢ≤1 for i=1, . . . , n; and a first normal probability distribution of a variable pa for each weight a of the n weights α₁, . . . , αₙ.

The following are performed in time step t(t=1, 2, . . . , N).

A context vector c(t) of dimension d is received from an external system that is external to the computer system.

For each weight a of the n weights α₁, . . . , αₙ: \tilde{μ}_{α} is randomly sampled from the first normal probability distribution.

α(t) is selected from the group consisting of α₁, . . . , and αₙ by having the selected α(t) maximize a function f_{α} of c(t) and \tilde{μ}_{α}.

For each arm k of K arms k₁, . . . , k_{K} wherein K≥2: (i) a function fix characterizing a contextual multi-armed bandit scenario and having a functional dependence on c(t) is determined and (ii) a function f₂ₖ characterizing a classical multi-armed bandit scenario and not having a functional dependence on c(t) is determined.

An arm k(t) is selected from the group consisting of k₁, . . . , and k_{K} by having the selected arm k(t) maximize [α(t)f₁ₖ+(1−α(t))f₂ₖ].

An electromagnetic signal is sent to a hardware machine capable of performing the action of the selected arm k(t). The electromagnetic signal directs the hardware machine to perform the action of the selected arm k(t).

An identification of a reward (rₖ₍ₜ₎) resulting from the capable hardware machine having performed the action of the selected arm k(t) is received, wherein 0≤rₖ₍ₜ₎≤1.

If t<T, updates for the next time step are performed. Performing the updates comprises updating the first normal probability distribution for α=α(t) as a function of c(t) and rₖ₍ₜ₎.

### BRIEF DESCRIPTION OF THE DRAWINGS

FIGS. 1A, 1B and 1C provide an evaluation of algorithms on a specific dataset for different levels of corrupted and missing context, in accordance with embodiments of the present invention.

FIG. 2 is a flow chart of a method for triggering actions in a sequence of time steps within a multi-armed bandit process with corrupted context, in accordance with embodiments of the present invention.

FIG. 3 is a flow chart of a process for determining functions f₁ₖ and f₂ₖ used in a step of FIG. 2, in accordance with embodiments of the present invention.

FIG. 4 is a flow chart of a process for performing updates for the next time step, in accordance with embodiments of the present invention.

FIG. 5 is a flow chart of a process for updating the first normal probability distribution for the next time step, in accordance with embodiments of the present invention.

FIG. 6 is a flow chart of a process for updating the second normal probability distribution for the next time step, in accordance with embodiments of the present invention.

FIG. 7 is a flow chart of a process for updating the Beta distribution for the next time step, in accordance with embodiments of the present invention.

FIGS. 8A-8E depict multiple embodiments of interaction among a computer system, an external system, and a hardware machine, in accordance with embodiments of the present invention.

FIG. 9 illustrates a computer system, in accordance with embodiments of the present invention.

FIG. 10 depicts a computing environment which contains an example of an environment for the execution of at least some of the computer code involved in performing the inventive methods, in accordance with embodiments of the present invention.

### DETAILED DESCRIPTION

### 1. Introduction

Embodiments of the present invention present a novel variant of the contextual bandit problem (i.e., the multi-armed bandit with side-information, or context, available to a decision-maker) where the context used at each decision may be corrupted (“useless context”). This new problem is motivated by certain on-line settings including clinical trial and recommendation applications. In order to address the corrupted-context setting, embodiments of the present invention combine the contextual bandit approach with a classical multi-armed bandit mechanism. Unlike standard contextual bandit methods, embodiments of the present invention are able to learn from all iterations, even those iterations with corrupted context, by improving the computing of the expectation for each arm. Promising empirical results are obtained on several real-life datasets.

Sequential decision making is a common problem in many practical applications where the agent must choose the best action to perform at each iteration in order to maximize the cumulative reward over some period of time.

An “agent” is defined, for embodiments of the present invention, as a computer, a computing device, a computer system, or a hardware machine that differs from a generic computer. In one embodiment, the action is performed on the hardware machine that functions as the agent. In one embodiment, the action is performed on the hardware machine where the agent is not the hardware machine and is either a computer, a computing device, or a computer system.

One of the key challenges is to achieve a good trade-off between the exploration of new actions and the exploitation of known actions. This exploration vs exploitation trade-off in sequential decision-making problems is often formulated as the multi-armed bandit (MAB) problem: given a set of bandit “arms”, each arm representing an action to be performed, each action associated with a fixed but unknown reward probability distribution. The agent selects an arm to play at each iteration, and receives a reward drawn according to the selected arm's reward distribution independently from the previous actions.

A particularly useful version of the MAB problem is the contextual multi-armed bandit (CMAB) problem, alternatively called the “contextual bandit problem”, where at each iteration before choosing an arm, the agent observes a d-dimensional context vector, alternatively called “feature vector”. Over time, embodiments of the present invention learn the relationship between the context vectors and the rewards, in order to make a better prediction of which arm (i.e., action) to choose, given the context. For example, the contextual bandit approach is commonly used in various practical sequential decision problems with side information (context), from clinical trials to recommender systems, where the patient's information (medical history, etc.) or an online user's profile provides a context for making a better decision about the treatment to propose, or an advertisement to show, and the reward represents the outcome of the selected action, such as, for example, success or failure of a particular treatment option.

Embodiments of the present invention consider a new problem setting, referred to as contextual bandit with corrupted and missing context, where the agent may not always observe the true context. This new problem setting is motivated by several real-life applications.

For example, in online advertisement, the user in front of the screen may not be the usual user who logs in (e.g., the user in front of the screen could be the usual user's brother), so the user profile (context) that the recommender system is using to recommend is not the correct user profile.

In another example, in medical decision-making settings, the doctor ordered a blood test but the test result is incorrect due to a problem in a machine used for the test. So, the doctor is using a corrupted and missing context (blood test results) to make decisions.

The corrupted and missing contextual bandit framework used for embodiments of the present invention aims to capture situations such as the situations previously described and provides an approach to always exploit the current interaction in order to improve future decisions. More specifically, embodiments of the present invention combine a contextual bandit algorithm with the classical multi-armed bandit, so that the MAB allows learning of a reward estimate with and without the observation of the correct context information, while the contextual bandit makes use of the right context information when the right context information is available. Several real-life datasets demonstrate infra that the approach of embodiments of the present invention outperforms the standard contextual bandit approach.

Previous approaches do not address the problem of the contextual bandit setting when the context could be useless due to some corruption, which is the main focus of embodiments of the present invention.

### 2. Problem Setting

Embodiments of the present invention address and solve a new type of a bandit problem: the contextual bandit with corrupted and missing context (CBCMC).

### 2.1 the Contextual Bandit Problem

The contextual bandit problem is defined as follows. At each time point (iteration) t∈{1, . . . , T}, a player is presented with a context (feature vector) c(t)∈R^{N} before choosing an arm k∈A={1, . . . , K}, wherein K≥2, wherein each arm represents an action to be performed, wherein K is a total number of arms, and wherein T is a total number of time iterations. C={C₁, . . . , C_{d}} denotes the set of features variables defining the context, wherein d is a total number of contexts. In embodiments of the present invention, the scope of “player” encompasses a computer, computing device, computer system, etc.

Let r=(r₁(t), . . . , r_{K}(t)) denote a reward vector rₖ(t)(k=1, . . . , K), wherein rₖ(t) is a reward at time t associated with the arm k∈A. In one embodiment, a focus is on the Bernoulli bandit with binary reward; i.e., rₖ(t) E{0, 1}. Generally, rₖ(t) is a real number normalized to be in a range of 0≤rₖ(t)≤1. Let π: C→A denote a policy. Also, D_{c,r} denotes a joint distribution (c, r). It is assumed that the expected reward is a linear function of the context; i.e., E[rₖ(t)|c(t)]=μₖ^{T}c(t) where μₖ is an unknown weight vector (to be learned from the data) associated with the arm k and c(t) is the context at time (iteration) t.

Context includes additional information or features that can influence the rewards associated with each arm (action) of the bandit, which helps in making more informed decisions about which arm (i.e., action) to choose in order to maximize the cumulative reward over time. The following examples illustrate context.

In online advertising in which there are different advertisements that may be selected for display and it is desired to display the advertisement most likely to attract the user, the context(s) may be selected from demographics of the user, time of day, location of the user, and browsing history of the user.

For recommender systems in which there are different products that may be recommended to the user, and it is desired to recommend the product most likely to be of interest to the user, the context(s) may be selected from user preferences, user browsing history, and user purchase history.

For different medical treatments that may be used to treat a patient recommended to the user wherein the different treatments are different arms, and it is desired to select the treatment most likely to have the best patient outcome, the context(s) may be selected from patient age, patient medical history, current symptoms of patient, and patient test results.

2.2 Contextual Bandit with Corrupted and Missing Context (CBCMC)

Algorithm 1, which is presented in Table 1, presents at a high-level the CBCMC setting, where ψ: c→ĉ, wherein c denotes the true context, ψ denotes a corrupting function, ĉ denotes the corrupted and/or missing context, and p_{ψ} is the probability that the context is corrupted by the function ψ. In this setting, it is assumed that the function ψ is unknown to the player and could not be recovered even though it is assumed that p_{ψ} is known (e.g., from collected statistical data).

TABLE 1
Algorithm 1: CBCMC Problem Setting

1: Foreach t = 1, 2, ..., T do
2: (c(t), r(t)) is drawn according to distribution D_{c,r}
3: c(t) = ĉ := ψ(c(t)) with probability p_{ψ}, or c(t) otherwise
4: The agent chooses an arm k(t) = π(c(t))
5: The reward rₖ(t) is revealed
6: The agent updates its policy π
7: End do

In Algorithm 1, which describes the CBCMC setting, line 4 recites that a context c(t) is received with a known probability p_{ψ} of being corrupted even though the function w is not known. Algorithm 1 does not utilize knowledge of p_{ψ} in choosing the arm k(t).

Definition 1 (Cumulative regret). The regret of a CBCMC-solving algorithm accumulated during T iterations is given as:

$$R ( T ) = {max}_{π ∈ Π} {Σ}_{t = 1}^{T} {r}_{π ( c ( t ) )} ( t ) - {Σ}_{t = 1}^{T} {r}_{k ( t )} ( t ) \qquad ( 1 )$$

Embodiments of the present invention present a method for solving the CBCMC problem, called Thompson Sampling with corrupted and missing context (TSCMC) in which the corruption is not detectable from the context. This method is summarized in Algorithm 2 which is presented in Table 2.

Algorithm 2 presents embodiments of the present invention in which at each time step t, an arm k(t) is selected based on a weighted linear combination of a contextual multi-armed bandit function and a classical multi-armed bandit function.

TABLE 2
Algorithm2: Thompson Sampling (TS) with
Corrupted and Missing Context (TSCMC)

```
  1: Inputs and initializations (time step t = 0): dimension (d) of each context vector;
number of arms (K); weights α₁, ..., αₙ; constant scalar values v₁² and v₂²; ∀k ∈
{1, ..., K}: Sₖ(0) = 0; Fₖ(0) = 0; Bₖ = I_{d}, \hat{μ}ₖ = 0_{d}, gₖ = 0_{d}; and ∀α ∈ { α₁, ..., αₙ}: B_{α}
= I_{d}, \hat{μ}_{α} = 0_{d}, g_{α} = 0_{d}
  2. Foreach t = 1, 2, ..., T do
```

| | |
|---|---|
| 3: | Observe context c(t) which is a vector of dimension d |
| 4: | Foreach parameter α₁, α₂, ... αₙ do |
| 5: | Sample \tilde{μ}_{α} from N(\hat{μ}_{α}, v₁²B_{α}⁻¹) distribution. |
| 6: | End do |
| 7: | Select α(t) = argmax c(t)^{T} \tilde{μ}_{α}, α ⊂ {α₁, ..., αₙ} |
| 8: | Foreach arm k = 1, ..., K do |
| 9: | Sample \tilde{μ}ₖ from N(\hat{μ}ₖ(t), v₂²Bₖ⁻¹) distribution |
| 10: | Sample θₖ from Beta (Sₖ, Fₖ) distribution |
| 11: | End do |
| 12: | Select arm k(t) = argmax (α(t)(c(t)^{τ} \tilde{μ}ₖ) + (1 − α(t)) θₖ), k ⊂ {1, ..., K} |
| 13: | Observe reward rₖ₍ₜ₎ for selected arm k(t), where 0 ≤ rₖ₍ₜ₎ ≤ 1 |
| 14: | If t < T |
| 15: | B_{α(t)} = B_{α(t)} + c(t)c(t)^{T}, g_{α(t)} = g_{α(t)} + c(t)rₖ(t), \hat{μ}_{α(t)} = B_{α(t)}⁻¹g_{α(t)} |
| 16: | Bₖ₍ₜ₎ = Bₖ₍ₜ₎ + c(t)c(t)^{T}, gₖ₍ₜ₎ = gₖ₍ₜ₎ + c(t)rₖ₍ₜ₎, \hat{μ}ₖ₍ₜ₎ = Bₖ₍ₜ₎⁻¹gₖ₍ₜ₎ |
| 17: | Sₖ₍ₜ₎ = Sₖ₍ₜ₎ + rₖ₍ₜ₎, Fₖ₍ₜ₎ = Fₖ₍ₜ₎ + (1 − rₖ₍ₜ₎) |
| 18: | End if |

19: End do

In line 1, inputs are received and initializations are performed. The specific initializations in line 1 are for illustrative purposes only and the scope of initializations that may be used in embodiments of the present invention is not limited to the specific initializations appearing in line 1. It is noted that Od is a d-dimensional vector of zeros, and I_{d} is a dxd unit matrix having diagonal elements of 1 and off-diagonal elements of 0.

After input is received and initialization has been performed in line 1, a time step iteration loop encompassing steps 2 to 19 for T timesteps is performed, wherein Tis at least 2.

In each time step t, a context c(t) is observed in line 3, followed in lines 4-6 by selection of \tilde{μ}ₐ from a multivariate normal probability distribution N(\hat{μ}_{α}, v₁²B_{α}⁻¹) distribution for each weight of the weights of α₁, α₂, . . . αₙ.

In line 7, α(t) is selected from {α₁, α₂, . . . , αₙ} via α(t)=argmax c(t)^{T} \tilde{μ}_{α}, wherein α(t) is a measure of a probability that the observed context is not corrupted.

For each arm k, lines 8-11 recite: (i) sampling \ddot{μ}k from a multivariate normal probability distribution N(\hat{μ}ₖ(t), v₂²Bₖ⁻¹) which considers the observed context and (ii) sampling θₖ from Beta (Sₖ, Fₖ) distribution which does not consider the observed context.

In line 12, arm k(t) is selected from 1, . . . , K via k(t)=argmax (α(t)[c(t)^{T}\tilde{μ}ₖ]+(1−α(t)) θₖ), where α(t) and (1−α(t)) serve to weight \ddot{μ}ₖ (which considers the context) sampled in line 9 and θₖ (which does not consider the context) sampled in line 10, respectively.

In line 13, the reward rₖ₍ₜ₎ is observed for the selected arm k(t).

Let rₖ(t) be the reward associated with the arm k(t) at time t. It is assumed that reward rₖ(t) in response to choosing arm k(t) at time t follows a parametric likelihood function Pr(r(t)|\tilde{μ}ₖ), and that the posterior distribution at time t+1 is Pr(\tilde{μ}|r(t))∝Pr(r(t)|\tilde{μ})Pr(\tilde{μ}). When the true context is observed, the posterior distribution is given by a multivariate normal distribution N(\hat{μ}ₖ(t+1), v₂²Bₖ(t+1)⁻¹), where Bₖ(t)=I_{d}+Σ_{τ=1}^{t-1}c(τ)c(τ)^{T} with d being the dimensional size of the context vectors c, and

$$v = R \sqrt{( \frac{24}{ϵ} ) d ln ( 1 / γ )}$$

with R>0, ϵ∈[0, 1], γ∈[0, 1], and \hat{μ}ₖ=Bₖ(t)⁻¹(Σ_{τ=1}^{t-1}c(τ)c(τ)^{T}).

A “posterior distribution” is a probability distribution associated with each arm k (K=1, . . . , K).

When corrupted and missing context is observed, it is assumed that the problem is a classical multi-armed bandit without context, so the posterior distribution is a beta distribution. At each time step t, and for each arm k, a d-dimensional \tilde{μ}ₖ is sampled from N(\hat{μ}ₖ(t), v₂²Bₖ(t)⁻¹) and the parameter θₖ is sampled from the corresponding Beta distribution of Beta (Sₖ, Fₖ) in accordance with the Thompson sampling strategy, after which an arm k(t) is chosen such that the chosen arm k(t) maximizes α(t)[c(t)^{T}\tilde{μ}ₖ]+(1−α(t))θₖ. Thus, α(t) and (1−α(t)) function as weights on the contextual multi-armed bandit and the classical multi-armed bandit, respectively, for choosing the arm k(t), wherein α(t) is a measure of a probability that that the observed context is not corrupted. The reward rₖ₍ₜ₎ in response to choosing the arm k(t) is observed, and relevant parameters are updated in lines 15-18, which includes Sₖ and Fₖ (in line 18) representing the current total number of successes and failures (as inferred from the rewards rₖ(t)received), respectively.

In one embodiment, n=2, α₁=1, and α₂=0. In this embodiment, Algorithm 2 is solving a bandit problem in which a selection of α=α₁=1 corresponds to the contextual multi-armed bandit, and a selection of α=α₂=0 corresponds to the classical multi-armed bandit.

### 2.3. Theoretical Analysis

This section pertains to both the regret upper bound for the TSCMC and the regret lower bound for the CBCMC.

Regret upper bound for the TSCMC. An upper bound on the regret is presented if the policy for the TSCMC is computed by the Thompson Sampling with corrupted and missing context of Algorithm 2. This regret is studied for two types of optimal policies. The optimal policy described infra in Definition 2 assumes having the optimal parameters for both the contextual MAB setting and the classical MAB setting.

Definition 2 (Optimal Policy). Definition 2 (Optimal Policy). The optimal policy for solving the CBCMC is as follow:

$$k ( t ) = arg max [ {{a * ( t ) {μ}_{k}^{*} ( t )}_{{k}_{⊂} \{ 1 , … , K \}}}^{⊤} c ( t ) + ( 1 - a * ( t ) θ * {( t )}_{k} ] \qquad ( 2 )$$

In Equation (2), α*, μₖ*, and θ* are respectively the optimal weight parameter, the optimal mean vector from the multivariate Normal distribution, and the optimal mean value from the Beta distribution.

Theorem 1. Using Definition 2 of the optimal policy, with probability 1-γ, where 0<γ<1, the regret R(T) accumulated by the TSCMC algorithm in T iterations is upper-bounded as follows:

$$R ( T ) \leq {( d γ / \text{?} ) [ {( T - τ )}^{( \text{?} + 1 )} ]}^{1 / 2} ( ln ( T - τ ) d ) ln ( 1 / γ ) + m with \qquad ( 3 )$$

$$E ( m ) \leq ( {\sum }_{k ∈ S} {( 1 / {Δ}_{k}^{2} )}^{2} ln T$$

$$\text{?} \text{indicates text missing or illegible when filed}$$

Theorem 1 is showing that the upper bound of the Thompson Sampling for CBCMC, is the combination of the two regrets obtained in the classical bandit setting and the contextual bandit setting.

Proof of Theorem 1: The preceding upper bound on R(t) is based on two key results presented in the following Lemma 1 and Lemma 2. See Shipra Agrawal and Navin Goyal, “Thompson sampling for contextual bandits with linear payoffs,” in ICML (3), 2013, pp. 127-135.

Lemma 1: With probability 1−γ, where 0<γ<1, the upper bound on the expected regret R(T) for the CTS in the contextual bandit problem with K arms and d features (context size) is given as follows: R(T)<(dγ/) [(T)^{(c+1)}]^{1/2} (1n(T)d)1n(1/γ)

Lemma 2: The upper bound on the regret R(T) for the TS (Algorithm 1) in the bandit problem with the set of S={1, . . . , K} arms is as follows:

$$E [ R ( T ) ] < ( {\sum }_{k ∈ S} {( 1 / {Δ}_{k}^{2} )}^{2} ln T$$

where Δk=μ*−μₖ, where μ* and μₖ are the expected rewards of the optimal arm and of the arm k∈S, respectively.

The total regret R(T) is split into two parts via R(T)=R(τ₁)+R(τ₂), where τ₁ is the number of time points within the first T iterations at which a sub-optimal policy was selected, and τ₂ is the number of times points when the best policy was used. Clearly, T=τ1+τ2. Note that τ₁=R_{bandit}(T), where R_{bandit}(T) is the regret of the bandit accumulated in the first part of the algorithm when looking for the optimal policy. Then R(T)=R_{bandit}(T)+R_{L2} (τ₂), where R_{L2} (τ₂) is the regret accumulated by the second level bandit algorithm, because while the algorithm is playing τ₂ times with the optimal policy, the algorithm is not making mistakes due to policy selection. So using Lemma 1 and Lemma 2, the first term and the second term of Equation (3) is upper bounded, which provides the final results.

Regret lower bound for the CBCMC. Here, a lower bound on the regret for the CBCMC is derived.

Theorem 2. For any algorithm solving the CBCMC problem with context size d, with (1−p_{ψ}) and 0≤p_{ψ}≤1, there exists a constant γ>0, such that the lower bound of the expected regret accumulated by the algorithm over T iterations is lower-bounded as follows: E[R(T)]>γ\sqrt{Td}, where p_{ψ} is the probability that the context is corrupted by an unknown function ψ.

Proof: The lower bound for E[R(T)] is based on the key result presented in the following Lemma 3. See Aure′lien Garivier and Eric Moulines,” On upper-confidence bound policies for non-stationary bandit problems,” in Algorithmic Learning Theory, October 2011, pp. 174-188.

Lemma 3. For any algorithm solving the contextual bandit problem with the context size d, there exists a constant γ>0 such that the lower bound of the expected regret accumulated by the algorithm over T iterations is lower-bounded as follows: E[R(T)]>γ\sqrt{Td}.

Theorem 2 shows that in a best-case scenario, any algorithm solving the CBCMC is going to have the same error lower bound as the classical contextual bandit setting as demonstrated in the following proof. The regret at time T is as follows: R(T)=R(T_{c})+R(T_{nc}) where T_{c} is the time that the agent obtained the corrupted and missing context, and T_{nc} is the time that the agent obtained the uncorrected context. From the problem definition, and with probability (1−p_{ψ}), it follows that R(T)=(T_{nc}) which is the best-case scenario in this setting. So, using Lemma 3 to lower bound R(T_{nc}) produces the final result.

### 3. Empirical Evaluation

Empirical evaluation of methods used different algorithms is based on four datasets from the University of California, Irving (UCI) Machine Learning Repository 1: Covertype, National Classification of Economic Activities-9 (CNAE-9), Internet Advertisements and Poker Hand.

In order to simulate a data stream, samples are drawn from each dataset sequentially, starting from the beginning each time the last sample is drawn. At each round, each algorithm receives the reward 1 if the instance is classified correctly, and reward 0 otherwise. The total number of classification errors is computed as a performance metric.

In Tables 3 and 4, the TSCMC algorithm used in embodiments of the present invention are compared with the following competing methods. (i) Multi-Arm Bandit (MAB) which is the Thomspon Sampling approach to (non-contextual) multi-arm bandit setting; (ii) Non-Stationary Multi-Arm Bandit (NSMAB) in which a sliding-window upper-confidence bound (SW-UCB) approach proposed in Garivier et al. [Aure lien Garivier and Eric Moulines, “On upper-confidence bound policies for non-stationary bandit problems,” in Algorithmic Learning Theory, October 2011, pp. 174-188] is used as a baseline to (non-contextual) multi-arm bandit setting; (iii) Contextual Bandit (CMAB) which is an algorithm that uses the contextual Thomspon Sampling (CTS).

The above algorithms (MAB, NSMAB, CMAB) and the TSCMC method used in embodiment of the present invention are executed for different corrupted and missing context subset sizes, such as 5%, 25%, 75% and 95% of corrupted and missing context, which is implemented by adding some contexts with random values in four datasets (Covertype, CNAE-9, Internet Advertisements, Poker Hand) being sampling from.

TABLE 3
Average Classification Error

| Datasets | MAB | NSMAB | CMAB | TSCMC |
|---|---|---|---|---|
| Covertype | 70.54 ± 0.30 | 75.27 ± 2.49 | 65.54 ± 4.57 | 63.44 ± 3.75 |
| CNAE-9 | 79.85 ± 0.35 | 82.01 ± 1.39 | 73.47 ± 3.55 | 70.47 ± 1.93 |
| Internet | 19.22 ± 0.20 | 21.33 ± 1.38 | 16.21 ± 2.54 | 70.47 ± 1.93 |
| Advertisements | | | | |
| Poker Hand | 62.29 ± 0.21 | 68.57 ± 1.17 | 58.82 ± 3.89 | 57.20 ± 0.91 |

TABLE 4
Number of Datasets, Features, and Classes

| Datasets | Instances | Features | Classes |
|---|---|---|---|
| Covertype | 581,013 | 95 | 7 |
| CNAE-9 | 1080 | 857 | 9 |
| Internet Advertisements | 3279 | 1558 | 2 |
| Poker Hand | 1,025,010 | 11 | 589 |

Table 3 presents the average classification error for each algorithm (MAB, NSMAB, CMAB, TSCMC) applied to each dataset (Covertype, CNAE-9, Internet Advertisements, and Poker Hand).

Table 4 presents the number of datasets, features, and classes into which the features are distributed for each dataset. The average classification error is the total number of misclassified samples averaged over the number of iterations. This average classification error for each algorithm was computed using 10 cyclical iterations over each dataset, and over the four different corrupted levels (5%, 25%, 75%, 95%) mentioned supra.

Overall, based on their mean error rate, Table 3 shows that the TSCMC approach has superior performance when compared to the MAB, NSMAB and CMAB algorithms, underscoring the importance of combining the multi-armed bandit with the contextual bandit in the TSCMC setting.

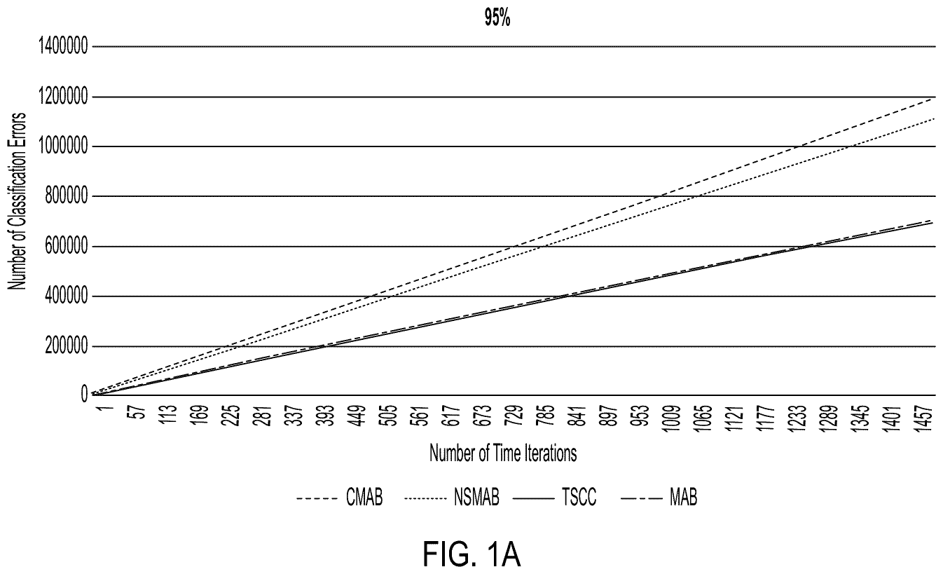

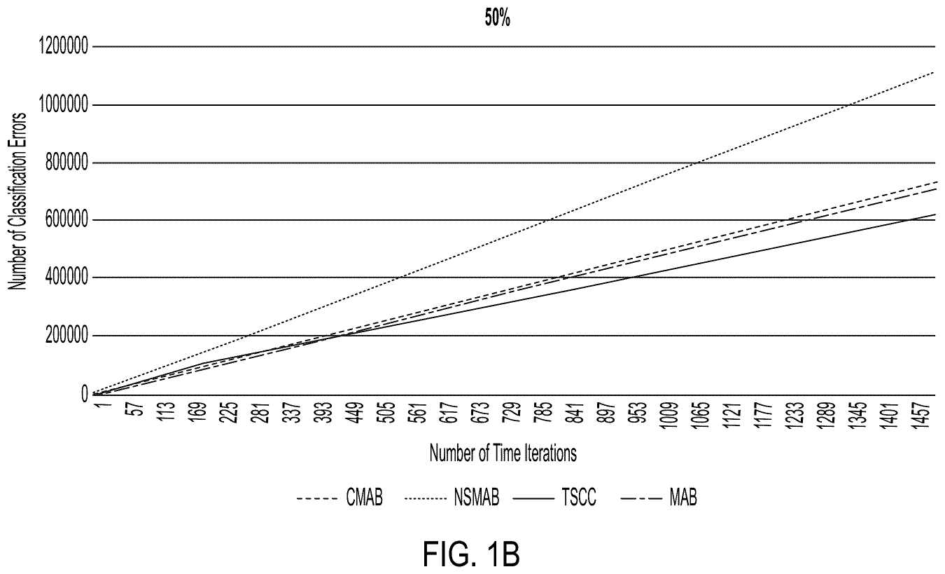

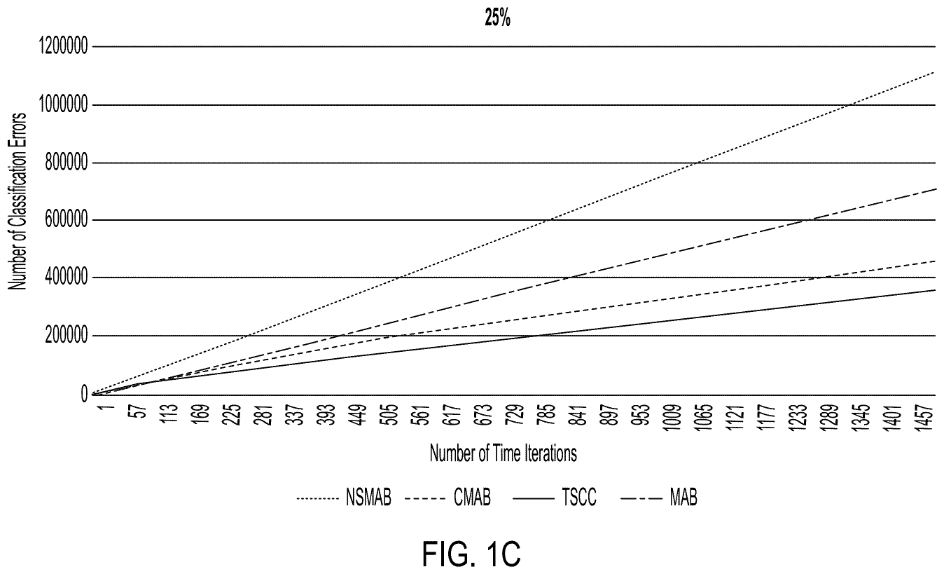

FIGS. 1A, 1B and 1C provide an evaluation of algorithms on a specific dataset for different levels of corrupted and missing contexts, in accordance with embodiments of the present invention. FIGS. 1A, 1B and 1C are each a plot of number of classification errors versus number of time iterations. The different levels of corrupted and missing contexts are 95%, 50% and 25% levels for FIGS. 1A, 1B and 1C, respectively. The algorithms are MAB, NSMAB, CMAB, and TSCMC (denoted as TSCC in FIGS. 1A, 1B and 1C). The specific dataset is Covertype.

For 95% corrupted (FIG. 1A), MAB has the lowest error out of all methods, followed tightly by NSMAB, suggesting that, ignoring the context in MAB may still be a better approach than doing the contextual bandit when the number of corrupted and missing context is high. It is noted that MAB has a lower error than the NSMAB, which means that a stationery algorithm is better to handle the corrupted and missing context compared with a non-stationary approach.

For 50% corrupted (FIG. 1B), TSCMC (i.e., TSCC) has the lowest error. However, at this 50% corruption level, CMAB and MAB have about a same level of accuracy.

For 25% corrupted (FIG. 1C), TSCMC (i.e., TSCC) has the lowest error, followed by the CMAB, which implies that at this 25% corruption level, a need for the MAB strategy is very low.

### 4. Inventive Methods

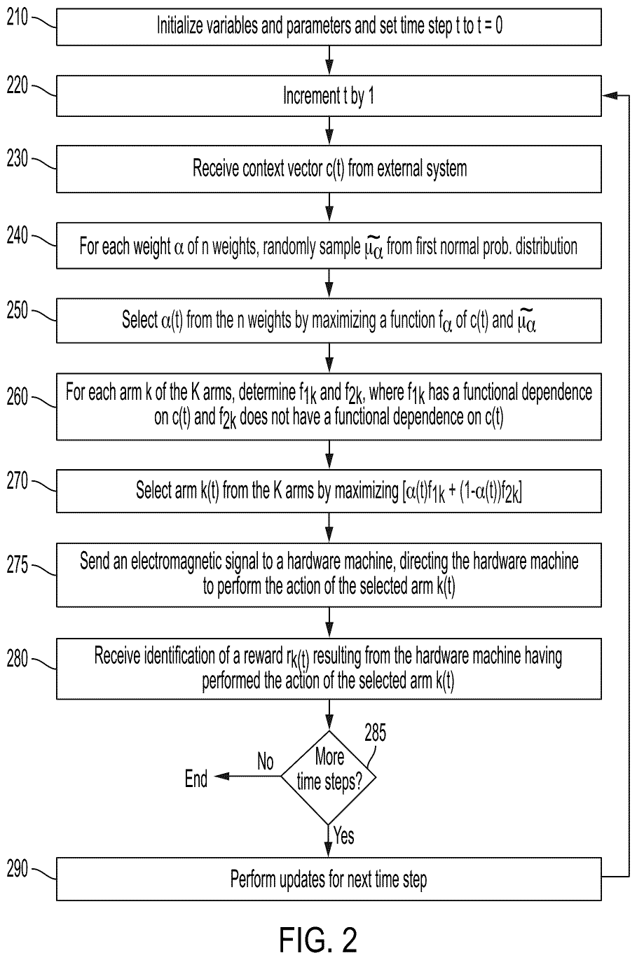

FIGS. 2-7 and 8A-8E describe implementations of Algorithm 2 as utilized in embodiments of the present invention.

FIG. 2 is a flow chart of a method for triggering actions in a sequence of time steps within a multi-armed bandit process with corrupted context, in accordance with embodiments of the present invention.

The method of FIG. 2 includes steps 210-290.

Steps 210-290 include performing, by one or more processors of a computer system, time steps t(t=0, 1, . . . , N), wherein N≥2. Thus, the total number of time steps is N+1.

Step 210 represents time step 0. Step 210 initializes variables and parameters, and sets time step t to t=0. The variables and parameters that are initialized comprise: a dimension d≥1 of each context vector to be observed; n weights denoted as α₁, . . . , αₙ such that n≥2 and 0<αᵢ≤1 for i=1, . . . , n; and a first normal probability distribution N(\hat{μ}ₐ, v₁²B_{α}⁻¹) of a variable \tilde{μ}ₐ for each weight α of the n weights α₁, . . . , αₙ which includes providing v₁² and initial values of μ_{α} and B_{α}; K arms 1 . . . , K; a second normal probability distribution N(\hat{μ}ₖ, v₂²Bₖ⁻¹) of a variable \hat{μ}ₖ for each arm k of the K arms 1, . . . , K which includes providing v₂² and initial values of gₖ, \tilde{μ}ₖ and Bₖ; a Beta (Sₖ, Fₖ) distribution of a variable θₖ for each arm k of the K arms 1, . . . , K which includes providing initial values of Sₖ and Fₖ.

In one embodiment, initialized values of the variables and parameters include, inter alia: d≥2; K≥2; weights α₁, . . . , αₙ=0, 0.25, 0.50, 75, 1.0 with n=5; for each k € {1, . . . , K}: Sₖ(0)=0; Fₖ(0)=0; Bₖ=I_{d}, \hat{μ}ₖ=0_{d}, gₖ=0_{d}; and for each α∈{α₁, . . . , αₙ}: B_{α}=I_{d}, \hat{μ}_{α}=0_{d}, g_{α}=0_{d}. The preceding specific initializations are for illustrative purposes only and the scope of initializations that may be used in embodiments of the present invention is not limited to the preceding specific initializations.

If d=1, then all vectors and matrices respectively having dimension d and dxd are scalars.

If d>2, then the first and second normal probability distributions are each a multivariate normal probability distributions.

Steps 220-290 form a loop such that steps 220-290 are performed in a time step t.

Step 220 increments t by 1 which initiates the next time step.

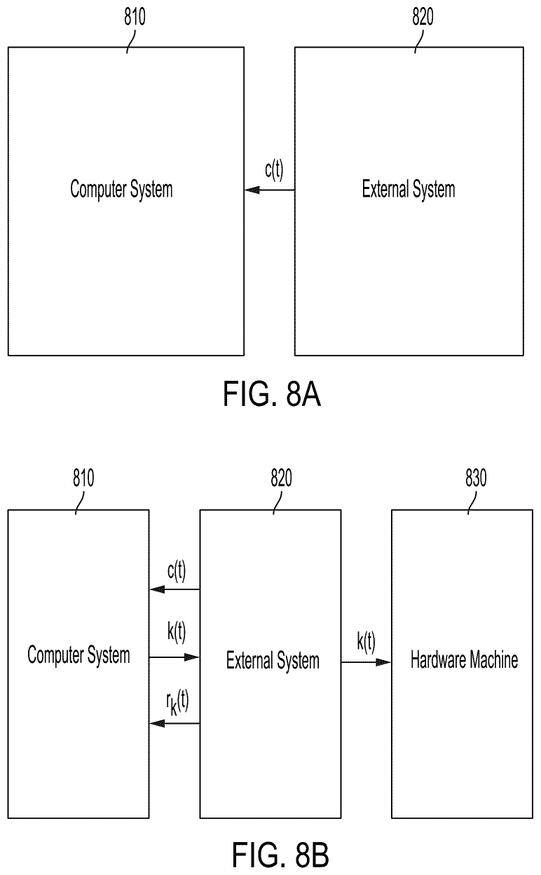

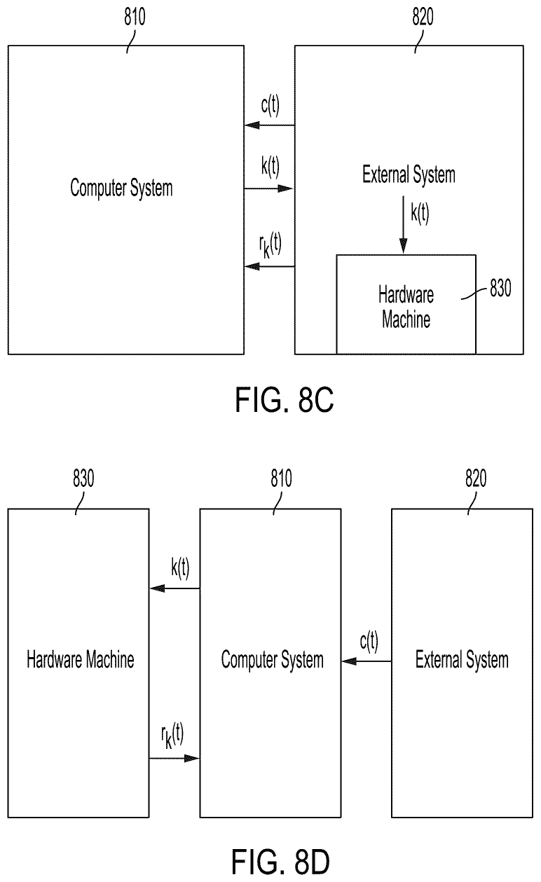

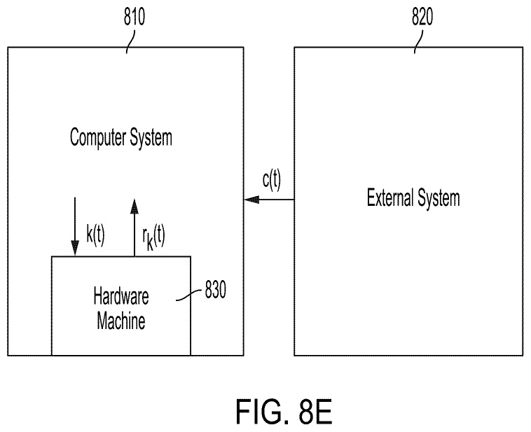

Step 230 receives, from an external system 820 that is external to the computer system 810 (see FIGS. 8A-8E discussed infra), a context vector (c(t)) of dimension d, wherein d≥1.

Step 240 randomly samples \tilde{μ}_{α} from the first normal probability distribution N(fa, v₁²B_{α}⁻¹) for each weight α of the n weights α₁, . . . , αₙ.

Step 250 selects α(t) from the group consisting of α₁, . . . , and an by having the selected α(t) to maximize a function f_{α} of c(t) and \tilde{μ}_{α}. In one embodiment, the function f_{α} of c(t) and pa is c(t)^{T} \tilde{μ}_{α}.

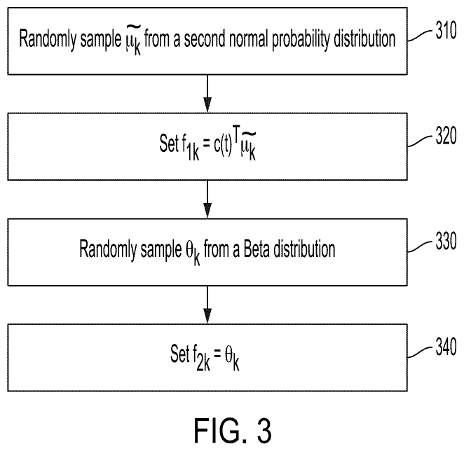

Step 260 determines, for each arm k of the K arms k₁, . . . , k_{K}: (i) a function f₁ₖ characterizing a contextual multi-armed bandit scenario and having a functional dependence on c(t) and (ii) a function f₂ₖ characterizing a classical multi-armed bandit scenario and not having a functional dependence on c(t). FIG. 3 describes an embodiment of step 260 for determining the functions f₁ₖ and f₂ₖ.

Step 270 selects arm k(t) from the group consisting of k₁, . . . , and k by having the selected arm k(t) maximize [α(t)f₁ₖ+(1−α(t))f₂ₖ].

Step 275 sends an electromagnetic signal to a hardware machine 830 (see FIGS. 8A-8E described infra). The electromagnetic signal directs the hardware machine 830 to perform the action of the selected arm k(t).

In one embodiment, the hardware machine 830 is capable of performing the action of any arm of the K arms k₁, . . . , k_{K}. Thus, in this embodiment, the electromagnetic signal is sent to the same hardware machine 830 regardless of which arm k(t) has been selected.

In one embodiment, the hardware machine 830 is one hardware machine Hₖ of K hardware machines H₁, . . . , HK such that hardware machine Hₖ is capable of performing the action of only arm k (k=1, . . . , K). Thus, in this embodiment, the electromagnetic signal is sent to hardware machine Hₖ₍ₜ₎ to perform the action of the selected arm k(t), so that the action of each of the K arms is performed by a different hardware machine that is specifically capable of performing the action of the selected arm k(t).

In one embodiment, the electromagnetic signal is a wired signal (e.g., via cable).

In one embodiment, the electromagnetic signal is a wireless signal via any of, inter alia, Wireless Fidelity (Wi-Fi), Bluetooth technology, Near Field Communication (NFC), Wireless Ethernet, etc.

In one embodiment, the hardware machine 830 is a computer.

In one embodiment, the hardware machine 830 is not a computer.

In one embodiment, the hardware machine 830 is not a generic computer.

In one embodiment, the hardware machine 830 is a specialized machine designed to perform specific functions with high efficiency and accuracy and are optimized for particular tasks, resulting in improved performance and/or reduced power consumption compared to general-purpose machines.

Examples of such specialized machine include, inter alia, an Application-Specific Integrated Circuit (ASIC) which is a custom-designed integrated circuit tailored to perform a specific application or task; Field-Programmable Gate Array (FPGA) which are semiconductor devices that can be programmed and reprogrammed to perform specific tasks after manufacturing; Neural Processing Unit (NPU) which is a specialized hardware accelerator designed to execute neural network models efficiently and may be used, inter alia, artificial (AI) applications; Tensor Processing Unit (TPU) which is a custom-designed AI accelerator optimized for executing machine learning workloads; Graphics Processing Unit (GPU) designed for rendering graphics and may be especially useful in parallel processing tasks due to their ability to handle a large number of calculations simultaneously; Digital Signal Processor (DSP) which is a specialized microprocessor optimized for processing digital signals, such as audio and video.

In one embodiment, the hardware machine 830 performs the action of the selected arm k(t) by performing a process selected from the group consisting of a mechanical process, an electrical process, a chemical process, a biological process, and any combination thereof.

Step 280 receives an identification of a reward (rₖ₍ₜ₎ resulting from the hardware machine 830 having performed the action of the selected arm k(t). The reward (rₖ₍ₜ₎ is normalized to be in the range of 0≤rₖ₍ₜ₎≤1.

Multiple embodiments of interaction among the computer system, the external system, and the hardware machine for implementing steps 230, 275, and 280 are described infra in FIGS. 8A-8E.

Step 285 determines whether more time steps are to be executed. If so (Yes; t<T) then the method performs step 290 followed by looping back to step 220 to perform the next time step. If not (No; t=T) then the method ends.

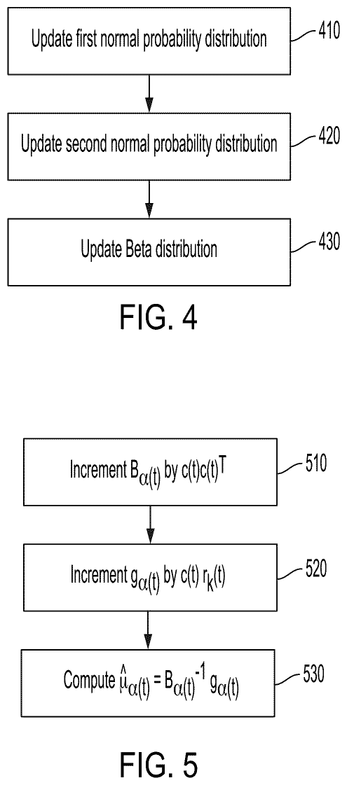

Step 290 performs updates for the next time step, which includes inter alia updating the first normal probability distribution for α=α(t) as a function of c(t) and rₖ₍ₜ₎. Step 290 is described infra in more detail in FIGS. 4-7.

FIG. 3 is a flow chart of a process for determining the functions f₁ₖ and f₂ₖ, in accordance with embodiments of the present invention. The process of FIG. 3 is an embodiment for implementing step 260 of FIG. 2. The process of FIG. 3 includes steps 310-340.

Step 310 randomly samples \tilde{μ}ₖ from a second normal probability distribution N(ûₖ(t), v₂²Bₖ⁻¹).

Step 320 sets f₁ₖ=c(t)^{T}\tilde{μ}ₖ.

Step 330 randomly samples θₖ from a Beta (Sₖ, Fₖ) distribution, wherein Sₖ and Fₖ) respectively denote a current total number of successes and failures.

Step 340 sets f₂ₖ=θₖ.

FIG. 4 is a flow chart of a process for performing updates for the next time step, in accordance with embodiments of the present invention. The process of FIG. 4 is an embodiment for implementing step 290 of FIG. 2. The process of FIG. 4 includes steps 410-430.

Step 410 updates the first normal probability distribution N(fa, v₁²B_{α}⁻¹). An embodiment of a process for implementing step 410 is described infra in FIG. 5.

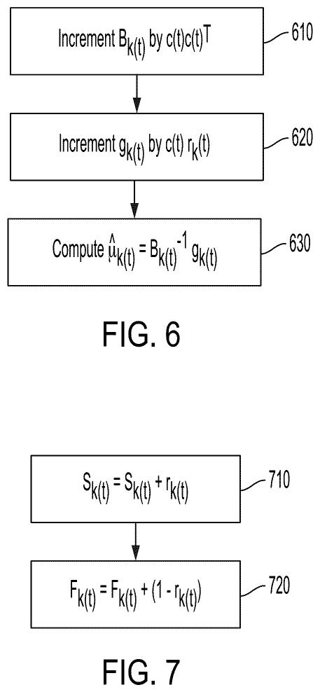

Step 420 updates the second normal probability distribution N(\hat{μ}k(t), v₂²Bₖ⁻¹). An embodiment of a process for implementing step 420 is described infra in FIG. 6.

Step 430 updates the Beta (Sₖ, Fₖ) distribution. An embodiment of a process for implementing step 430 is described infra in FIG. 7.

FIG. 5 is a flow chart of a process for updating the first normal probability distribution N(fa, v₁²Ba 1) for the next time step, in accordance with embodiments of the present invention. The process of FIG. 5 is an embodiment for implementing step 410 of FIG. 4. The process of FIG. 5 includes steps 510-530.

Step 510 increments B_{α(t)} by c(t)c(t)^{T}.

Step 520 increments g_{α(t)} by c(t)rₖ(t).

Step 530 computes \hat{μ}_{α(t)}=B_{α(t)}⁻¹g_{α(t)}.

FIG. 6 is a flow chart of a process for updating the second normal probability distribution N(\hat{μ}ₖ(t), v₂²Bₖ⁻¹) for the next time step, in accordance with embodiments of the present invention. The process of FIG. 6 is an embodiment for implementing step 420 of FIG. 4. The process of FIG. 6 includes steps 610-630.

Step 610 increments Bₖ(t) by c(t)c(t)^{T}.

Step 620 increments gₖ₍ₜ₎ by c(t)rₖ(t).

Step 630 computes \hat{μ}ₖ(t)=Bₖ₍ₜ₎⁻¹gₖ₍ₜ₎.

FIG. 7 is a flow chart of a process for updating the Beta (Sₖ, Fₖ) distribution for the next time step, in accordance with embodiments of the present invention. The process of FIG. 7 is an embodiment for implementing step 430 of FIG. 4. The process of FIG. 7 includes steps 710-720.

Step 710 computes Sₖ₍ₜ₎=Sₖ₍ₜ₎+rₖ₍ₜ₎.

Step 720 computes Fₖ₍ₜ₎=Fₖ₍ₜ₎+(1−rₖ₍ₜ₎).

FIGS. 8A-8E depict multiple embodiments of interaction among a computer system 810, an external system 820, and a hardware machine 830 for implementing steps 230, 275, and 280 of FIG. 2, in accordance with embodiments of the present invention.

FIG. 8A depicts the external system 820 sending a context c(t) to the computer system 810 in accordance with step 230 of FIG. 2.

FIGS. 8B-8D depict the computer system 810, the external system 820, and the hardware machine 830 in various configuration. In each configuration, the external system 820 sends a context c(t) to the computer system 810 in accordance with step 230 of FIG. 2.

In FIG. 8B, the hardware machine 830 is external to both the computer system 810 and the external system 820 and is communicatively coupled to the external machine 820. The computer system 810 sends an identification of the action of the arm k(t) indirectly to the hardware machine 830, by sending the identification of the action of the arm k(t) to the external system 820 followed by the external system 820 sending the identification of the action of the arm k(t) to the hardware machine 830. After the hardware machine 830 performs the action of the arm k(t), the external machine sends to the computer system 810 the reward rₖ(t) or information sufficient for determining the reward rₖ(t)resulting from performance of the action of the arm k(t) by the hardware machine 830.

In FIG. 8C, the hardware machine 830 is internal within the external system 820. The computer system 810 sends an identification of the action of the arm k(t) to the hardware machine 830, by (i) sending the identification of the action of the arm k(t) directly to the hardware machine 830 or (ii) sending the identification of the action of the arm k(t) to a portion of the external system 820 that is external to the hardware machine 830 followed by the external system 820 sending the identification of the action of the arm k(t) directly to the hardware machine 830. After the hardware machine 830 performs the action of the arm k(t), the external machine sends to the computer system 810 the reward rₖ(t), or information sufficient for determining the reward rₖ(t), resulting from performance of the action of the arm k(t) by the hardware machine 830.

In FIG. 8D, the hardware machine 830 is external to both the computer system 810 and the external system 820 and is communicatively coupled to the computer system 810. The computer system 810 sends an identification of the action of the arm k(t) directly to the hardware machine 830. After the hardware machine 830 performs the action of the arm k(t), the hardware machine 830 sends to the computer system 810 the reward rₖ₍ₜ₎ or information sufficient for determining the reward rₖ(t), resulting from performance of the action of the arm k(t) by the hardware machine 830.

In FIG. 8E, the hardware machine 830 is internal within the computer system 810. The computer system 810 sends an identification of the action of the arm k(t) to the hardware machine 830. After the hardware machine 830 performs the action of the arm k(t), the hardware machine communicates to the computer system 810 the reward rₖ(t), or information sufficient for determining the reward rₖ₍ₜ₎ resulting from performance of the action of the arm k(t) by the hardware machine 830.

Tables 5-8 are Examples 1-4, respectively, which describe practical applications of embodiments of the present invention.

TABLE 5
Example 1

| | |
|---|---|
| Function | routing of packets between nodes of a network |
| of Example | or between nodes of different networks |
| Hardware | network switch (for routing packets within a network) |
| Machine | or router (for routing packets between networks) |
| Context | network traffic volume, network topology, network |
| | interference or noise from other devices |
| Arms/Actions | for a given source node and destination node, selection |
| | of which network path to use for routing the packet |
| | from the source node to the destination node |
| Rewards | network latency (time for a packet to be routed |
| | between nodes in a network or between networks) |

TABLE 6
Example 2

| | |
|---|---|
| Function | selection of printer (from multiple printers in a |
| of Example | computer system) to print the output of a job that was |
| | executed by a hardware server in the computer system |
| Hardware | printer |
| Machine | |
| Context | size of the output, print jobs in buffer |
| | of each of the multiple printers |
| Arms/Actions | the multiple printers which may print the output |
| Rewards | time from sending the output to the printer |
| | to completion of the printing of the output |

TABLE 7
Example 3

| | |
|---|---|
| Function | control of self-navigating ship sailing in ocean |
| of Example | using an on-board computer to navigate the ship |
| Hardware | self-navigating ship |
| Machine | |
| Context | conditions at current location of ship (e.g., |
| | ocean waves and roughness, presence of nearby ships, |
| | current ocean depth); weather conditions (e.g., |
| | precipitation, wind speed and direction) |
| Arms/Actions | changing direction of ship motion, |
| | accelerating or decelerating ship motion, |
| | invoking ship stabilization apparatus in ship |
| Rewards | optimizing fuel efficiency, minimizing travel |
| | time to reach destination of ship |

TABLE 8
Example 4

| | |
|---|---|
| Function | operation by robotic arms to perform |
| of Example | real-time surgery on tissue of a patient |
| Hardware | robotic arms |
| Machine | |
| Context | characteristics of the tissue being treated (bleeding, |
| | color, swelling), patient data (blood pressure, pulse |
| | rate, oxygen level, bleeding); environmental factors |
| | (lighting, temperature, humidity) |
| Arms/Actions | change robotic arm operational parameters (motion |
| | speed and direction, power) in each time step |
| Rewards | minimize removal of healthy tissue, minimize duration |
| | of each time step and time of overall process |

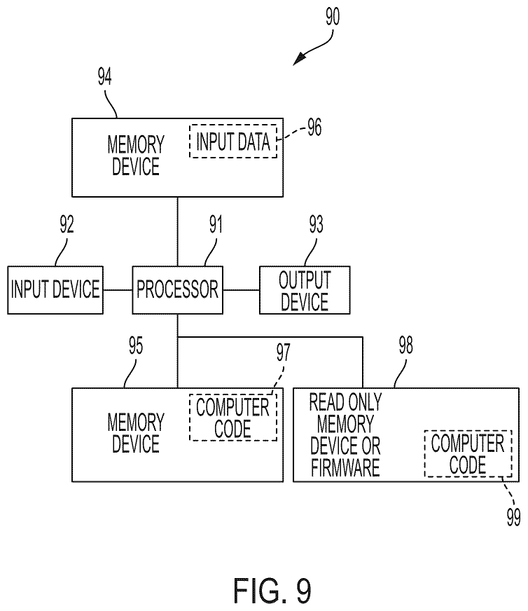

FIG. 9 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

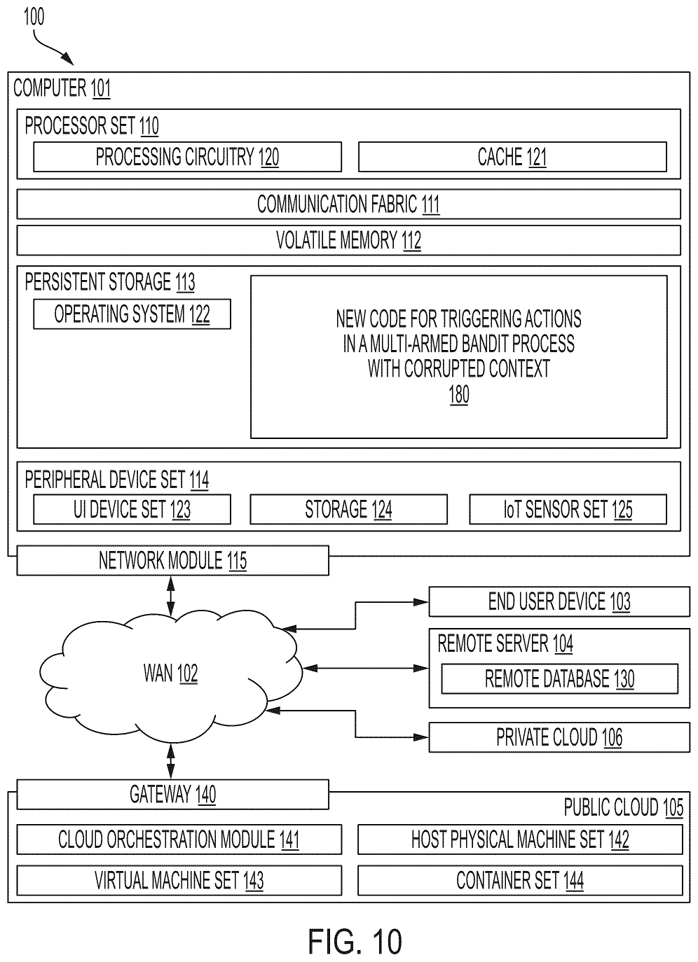

FIG. 10 depicts a computing environment 100 which contains an example of an environment for the execution of at least some of the computer code involved in performing the inventive methods, in accordance with embodiments of the present invention. Such computer code includes new code for triggering actions in a multi-armed bandit process with corrupted context 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 10. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for triggering actions within a multi-armed bandit process with corrupted context, said method comprising:
sequentially performing, by one or more processors of a computer system, time steps t (t=0, 1, . . . , T), wherein T≥2,
wherein performing time step 0 comprises: initializing variables and parameters comprising a dimension d≥1 of each context vector to be observed; n weights denoted as α₁, . . . , αₙ such that 0<αᵢ≤1 for i=1, . . . , n; and a first normal probability distribution of a variable \tilde{μ}_{α}for each weight α of the n weights α₁, . . . , αₙ;
wherein performing time step t(t=1, . . . , T) comprises:
receiving, from an external system that is external to the computer system, a context vector c(t) of dimension d;
for each weight α of the n weights α₁, . . . , αₙ: randomly sampling \tilde{μ}ₐ from the first normal probability distribution;
selecting α(t) from the group consisting of α₁, . . . , and αₙ by having the selected α(t) maximize a function f_{α} of c(t) and \tilde{μ}_{α};
for each arm k of K arms k₁, . . . , k_{K} wherein K≥2: (i) determining a function f₁ₖ characterizing a contextual multi-armed bandit scenario and having a functional dependence on c(t) and (ii) determining a function f₂ₖ characterizing a classical multi-armed bandit scenario and not having a functional dependence on c(t);
selecting arm k(t) from the group consisting of k₁, . . . , and k_{K} by having the selected arm k(t) maximize [α(t)f₁ₖ+(1−α(t))f₂ₖ];
sending an electromagnetic signal to a hardware machine capable of performing the action of the selected arm k(t), said electromagnetic signal directing the hardware machine to perform the action of the selected arm k(t);
receiving an identification of a reward (rₖ₍ₜ₎ resulting from the capable hardware machine having performed the action of the selected arm k(t), wherein 0≤rₖ₍ₜ₎≤1;
if t<T, performing updates for the next time step, said performing updates comprising updating the first normal probability distribution for α=α(t) as a function of c(t) and rₖ₍ₜ₎.

2. The method of claim 1, wherein f_{α}=c(t)^{T}\tilde{μ}_{α}.

3. The method of claim 1,
wherein the first normal probability distribution is N(fa, v₁²B_{α}⁻¹);
wherein said initializing variables and parameters comprises setting v₁² to a first constant value and, for each weight α of the n weights α₁, . . . , αₙ, setting B_{α}, \hat{μ}_{α}, and g_{α} to initial values; and
wherein said performing updates comprises updating the first normal probability distribution for α=α(t) via: incrementing B_{α(t)} by c(t)c(t)^{T}, incrementing g_{α(t)} by c(t)rₖ(t), and computing \hat{μ}_{α(t)}=B_{α(t)}⁻¹gₐ₍ₜ₎.

4. The method of claim 1,
wherein said determining f₁ₖ comprises:
(i) for each arm k of the K arms k₁, . . . , k_{K}, randomly sampling \tilde{μ}ₖ from a second normal probability distribution N(ûₖ(t), v₂²Bₖ⁻¹), wherein said initializing variables and parameters comprises setting v₂² to a second constant value;
(ii) for each arm k of the K arms k₁, . . . , k_{K}, setting, during said initializing variables and parameters, Bₖ, \hat{μ}ₖ, and gₖ to initial values; and
(iii) for each arm k of the K arms k₁, . . . , k_{K}, setting f₁ₖ=c(t)^{T} \tilde{μ}ₖ;
wherein said determining f₂ₖ comprises:
(iv) for each arm k of the K arms k₁, . . . , k_{K}, randomly sampling θₖ from a Beta (Sₖ, Fₖ) distribution, wherein Sₖ and Fₖ respectively denote a current total number of successes and failures for arm k;
(v) for each arm k of the K arms k₁, . . . , k_{K}, setting, during said initializing variables and parameters, Sₖ and Fₖ to initial values; and
(vi) for each arm k of the K arms k₁, . . . , k_{K}, setting f₂ₖ=θₖ.

5. The method of claim 4, wherein said performing updates comprises:
updating the second normal probability distribution N(\hat{μ}ₖ(t), v₂²Bₖ⁻¹) for the selected arm k(t) via: incrementing Bₖ₍ₜ₎ by c(t)c(t)^{T}, incrementing gₖ₍ₜ₎ by c(t)rₖ(t), and computing \hat{μ}ₖ₍ₜ₎=Bₖ₍ₜ₎⁻¹gₖ₍ₜ₎; and
updating the Beta (Sₖ, Fₖ) distribution comprises via: computing Sₖ₍ₜ₎=Sₖ₍ₜ₎+rₖ₍ₜ₎ and Fₖ₍ₜ₎=Fₖ₍ₜ₎+(1−rₖ₍ₜ₎).

6. The method of claim 1, wherein the hardware machine is not a generic computer.

7. The method of claim 1, wherein the hardware machine is a computing device.

8. The method of claim 1, wherein the hardware machine is an Application-Specific Integrated Circuit (ASIC), a Field-Programmable Gate Array (FPGA), a Neural Processing Unit (NPU), a Tensor Processing Unit (TPU), Graphics Processing Unit (GPU), or Digital Signal Processor (DSP).

9. The method of claim 1, wherein the external system comprises the hardware machine.

10. The method of claim 9, wherein said sending the signal comprises transmitting the electromagnetic signal indirectly to the hardware machine in the external system via a computing device in the external system, said computing device configured to receive the transmitted electromagnetic signal and to subsequently send the transmitted electromagnetic signal to the hardware machine.

11. A computer program product, comprising one or more computer readable hardware storage devices having computer readable program code stored therein, said program code containing instructions executable by one or more processors of a computer system to implement a method for triggering actions within a multi-armed bandit process with corrupted context, said method comprising:
sequentially performing, by the one or more processors, time steps t(t=0, 1, . . . , T), wherein T≥2,
wherein performing time step 0 comprises: initializing variables and parameters comprising a dimension d≥1 of each context vector to be observed; n weights denoted as α₁, . . . , αₙ such that 0≤αᵢ≤1 for i=1, . . . , n; and a first normal probability distribution of a variable μ_{α} for each weight α of the n weights α₁, . . . , αₙ,
wherein performing time step t(t=1, . . . , T) comprises:
receiving, from an external system that is external to the computer system, a context vector c(t) of dimension d;
for each weight α of the n weights α₁, . . . , αₙ: randomly sampling Da from the first normal probability distribution;
selecting α(t) from the group consisting of α₁, . . . , and αₙ by having the selected α(t) maximize a function f_{α} of c(t) and \tilde{μ}_{α};
for each arm k of K arms k₁, . . . , k_{K} wherein K≥2: (i) determining a function f₁ₖ characterizing a contextual multi-armed bandit scenario and having a functional dependence on c(t) and (ii) determining a function f₂ₖ characterizing a classical multi-armed bandit scenario and not having a functional dependence on c(t);
selecting arm k(t) from the group consisting of k₁, . . . , and k_{K} by having the selected arm k(t) maximize [α(t)f₁ₖ+(1−α(t))f₂ₖ];
sending an electromagnetic signal to a hardware machine capable of performing the action of the selected arm k(t), said electromagnetic signal directing the hardware machine to perform the action of the selected arm k(t);
receiving an identification of a reward (rₖ₍ₜ₎ resulting from the capable hardware machine having performed the action of the selected arm k(t), wherein 0≤rₖ₍ₜ₎≤1;
if t<T, performing updates for the next time step, said performing updates comprising updating the first normal probability distribution for α=α(t) as a function of c(t) and rₖ₍ₜ₎.

12. The method of claim 11, wherein f_{α}=c(t)^{T}\tilde{μ}_{α}.

13. The method of claim 1,
wherein the first normal probability distribution is N(fa, v₁²B_{α}⁻¹);
wherein said initializing variables and parameters comprises setting v₁² to a first constant value and, for each weight α of the n weights α₁, . . . , αₙ, setting B_{α}, \hat{μ}_{α}, and g_{α} to initial values; and
wherein said performing updates comprises updating the first normal probability distribution for α=α(t) via: incrementing B_{α(t)} by c(t)c(t)^{T}, incrementing g_{α(t)} by c(t)rₖ(t), and computing \tilde{μ}_{α(t)}=B_{α(t)}⁻¹gₐ₍ₜ₎.

14. The method of claim 11,
wherein said determining f₁ₖ comprises:
(i) for each arm k of the K arms k₁, . . . , k_{K}, randomly sampling \tilde{μ}ₖ from a second normal probability distribution N(\hat{μ}ₖ(t), v₂²Bₖ⁻¹), wherein said initializing variables and parameters comprises setting v₂² to a second constant value;
(ii) for each arm k of the K arms k₁, . . . , k_{K}, setting, during said initializing variables and parameters, Bₖ, k, and gₖ to initial values; and
(iii) for each arm k of the K arms k₁, . . . , k_{K}, setting f₁ₖ=c(t)^{T} fix;
wherein said determining f₂ₖ comprises:
(iv) for each arm k of the K arms k₁, . . . , k_{K}, randomly sampling θₖ from a Beta (Sₖ, Fₖ) distribution, wherein Sₖ and Fₖ respectively denote a current total number of successes and failures for arm k;
(v) for each arm k of the K arms k₁, . . . , k_{K}, setting, during said initializing variables and parameters, Sₖ and Fₖ to initial values; and
(vi) for each arm k of the K arms k₁, . . . , k_{K}, setting f₂ₖ=θₖ.

15. The method of claim 14, wherein said performing updates comprises:
updating the second normal probability distribution N(\hat{μ}ₖ(t), v₂²Bₖ⁻¹) for the selected arm k(t) via: incrementing Bₖ(t) by c(t)c(t)^{T}, incrementing gₖ₍ₜ₎ by c(t)rₖ(t), and computing \hat{μ}ₖ(t)=Bₖ₍ₜ₎⁻¹gₖ₍ₜ₎; and
updating the Beta (Sₖ, Fₖ) distribution comprises via: computing Sₖ₍ₜ₎=Sₖ₍ₜ₎+rₖ₍ₜ₎ and Fₖ₍ₜ₎=Fₖ₍ₜ₎+(1−rₖ₍ₜ₎).

16. A computer system, comprising one or more processors, one or more memories, and one or more computer readable hardware storage devices, said one or more hardware storage devices containing program code executable by the one or more processors via the one or more memories to implement a method for triggering actions within a multi-armed bandit process with corrupted context, said method comprising:
sequentially performing, by the one or more processors, time steps t(t=0, 1, . . . , T), wherein T≥2,
wherein performing time step 0 comprises: initializing variables and parameters comprising a dimension d≥1 of each context vector to be observed; n weights denoted as α₁, . . . , αₙ such that 0≤αᵢ≤1 for i=1, . . . , n; and a first normal probability distribution of a variable \tilde{μ}ₐ for each weight α of the n weights α₁, . . . , αₙ,
wherein performing time step t(t=1, . . . , T) comprises:
receiving, from an external system that is external to the computer system, a context vector c(t) of dimension d;
for each weight α of the n weights α₁, . . . , αₙ: randomly sampling pa from the first normal probability distribution;
selecting α(t) from the group consisting of α₁, . . . , and αₙ by having the selected α(t) maximize a function f_{α} of c(t) and \tilde{μ}ₐ;
for each arm k of K arms k₁, . . . , k_{K} wherein K≥2: (i) determining a function f₁ₖ characterizing a contextual multi-armed bandit scenario and having a functional dependence on c(t) and (ii) determining a function f₂ₖ characterizing a classical multi-armed bandit scenario and not having a functional dependence on c(t);
selecting arm k(t) from the group consisting of k₁, . . . , and k_{K} by having the selected arm k(t) maximize [α(t)f₁ₖ+(1−α(t))f₂ₖ];
sending an electromagnetic signal to a hardware machine capable of performing the action of the selected arm k(t), said electromagnetic signal directing the hardware machine to perform the action of the selected arm k(t);
receiving an identification of a reward (rₖ₍ₜ₎) resulting from the capable hardware machine having performed the action of the selected arm k(t), wherein 0≤rₖ₍ₜ₎≤1;
if t<T, performing updates for the next time step, said performing updates comprising updating the first normal probability distribution for α=α(t) as a function of c(t) and rₖ₍ₜ₎.

17. The method of claim 16, wherein f_{α}=c(t)^{T}\tilde{μ}_{α}.

18. The method of claim 16,
wherein the first normal probability distribution is N(μ_{α}, v₁²B_{α}⁻¹);
wherein said initializing variables and parameters comprises setting v₁² to a first constant value and, for each weight α of the n weights α₁, . . . , αₙ, setting B_{α}, \hat{μ}_{α}, and g_{α} to initial values; and
wherein said performing updates comprises updating the first normal probability distribution for α=α(t) via: incrementing B_{α(t)} by c(t)c(t)^{T}, incrementing g_{α(t)} by c(t)rₖ(t), and computing \tilde{μ}ₐ₍ₜ₎=B_{α(t)}⁻¹gₐ₍ₜ₎.

19. The method of claim 16,
wherein said determining f₁ₖ comprises:
(i) for each arm k of the K arms k₁, . . . , k_{K}, randomly sampling μₖ from a second normal probability distribution N(\hat{μ}ₖ(t), v₂²B^{k-1}), wherein said initializing variables and parameters comprises setting v₂² to a second constant value;
(ii) for each arm k of the K arms k₁, . . . , k_{K}, setting, during said initializing variables and parameters, Bₖ, \hat{μ}ₖ, and gₖ to initial values; and
(iii) for each arm k of the K arms k₁, . . . , k_{K}, setting f₁ₖ=c(t)^{T}μₖ;
wherein said determining f₂ₖ comprises:
(iv) for each arm k of the K arms k₁, . . . , k_{K}, randomly sampling θₖ from a Beta (Sₖ, Fₖ) distribution, wherein Sₖ and Fₖ respectively denote a current total number of successes and failures for arm k;
(v) for each arm k of the K arms k₁, . . . , k_{K}, setting, during said initializing variables and parameters, Sₖ and Fₖ to initial values; and
(vi) for each arm k of the K arms k₁, . . . , k_{K}, setting f₂ₖ=θₖ.

20. The method of claim 19, wherein said performing updates comprises:
updating the second normal probability distribution N(\hat{μ}k(t), v₂²B^{k-1}) for the selected arm k(t) via: incrementing Bₖ(t) by c(t)c(t)^{T}, incrementing gₖ₍ₜ₎ by c(t)rₖ(t), and computing \hat{μ}ₖ(t)=Bₖ₍ₜ₎⁻¹gₖ₍ₜ₎; and
updating the Beta (Sₖ, Fₖ) distribution comprises via: computing Sₖ₍ₜ₎=Sₖ₍ₜ₎+rₖ₍ₜ₎ and Fₖ₍ₜ₎=Fₖ₍ₜ₎+(1−rₖ₍ₜ₎).
